(19) United States
(12) Patent Application Publication
(10) Pub. No.: US 2005/0162130 A1
(43) Pub. Date: Jul. 28, 2005

(54) Balancing the voltages of electrochemical cells in a rechargeable battery by means of two-terminal circuits

(75) Inventor: Xavier Petitdidier, (US)

Correspondence Address: SUGHRUE MION, PLLC, 2100 PENNSYLVANIA AVENUE, N.W., SUITE 800, WASHINGTON, DC, 20037, US

(73) Assignee: SAFT

(21) Appl. No.: 11/012,163

(22) Filed: Dec. 16, 2004

(30) Foreign Application Priority Data
Dec. 16, 2003 (FR) 0314701

(51) Int. Cl. H02J 7/00

(52) U.S. Cl. 320/116; 320/119

(57) ABSTRACT

A battery comprises at least two modules connected in series via their terminals and each comprising at least one electrochemical cell, together with two-terminal balancing circuits each connected in parallel across the terminals of a corresponding one of the modules and serving to take a permanent discharge current in the corresponding module as a function of the voltage across its terminals.

The invention relates to the field of batteries of electrochemical cells, and more particularly rechargeable batteries provided with devices for balancing the voltages of the electrochemical modules making them up.

### BACKGROUND OF THE INVENTION

Certain rechargeable batteries are constituted by at least two modules connected in series and each comprising at least one electrochemical cell (also known as a “secondary” or “rechargeable cell”, or indeed as an “accumulator”).

The voltage measured across the terminals of such batteries depends on the state of the charge in the electrochemical cells making up their modules, and said state of charge is frequently subjected to monitoring by devices for controlling or balancing voltage so as to ensure that none of the electrochemical cells is subjected to overcharging or to high rates of discharge that could reduce the performance of a battery, and above all that could limit its lifetime.

Very many voltage controlling or balancing devices have already been proposed. They can be subdivided into two main types.

A first type combines devices having a dedicated circuit designed specifically for a given type of battery and thus for a given number of modules in series (generally less than or equal to four), corresponding to a given voltage. Each dedicated circuit generally comprises a digital processor module such as an application specific integrated circuit (ASIC), serving to compare measurements performed on the various modules and to decide on the actions to be undertaken on said modules. That type of device is generally inexpensive, but presents the drawback of not being adaptable.

A second type groups together devices having an analog type system taking various states as a function of measurement comparisons performed on the various modules. This type of device is generally adaptable, but because of its complexity and because of problems associated with common modes between circuits, it is generally restricted to voltages of less than 100 volts (V).

### OBJECTS AND SUMMARY OF THE INVENTION

Since none of the prior art devices provide complete satisfaction, the invention seeks to improve the situation.

To this end, the invention provides a battery comprising at least two modules connected in series via their terminals and each comprising each at least one electrochemical cell, and two-terminal balancing circuits each connected in parallel across the terminals of each module and serving to take a permanent discharge current from the corresponding module as a function of the voltage across its terminals.

The term “two-terminal circuit” is used herein to mean a component or circuit element having two terminals, or a combination of two-terminal circuit components connected in series and presenting an off state and an on state as a function of the voltage across its terminals.

Thus, by appropriately selecting the (two-terminal circuit) components making up a balancing circuit, it is possible to take a permanent discharge current that makes the self-discharge current of the associated module negligible.

Where necessary (because of the self-discharge current concerned), each module may be connected via its terminals to a balancing circuit comprising a plurality of two-terminal circuits connected in series and serving to act together on the module to take a permanent discharge current of greater magnitude, as a function of the voltage across its terminals.

The balancing circuits can be made in various ways. For example, each two-terminal element of a balancing circuit may comprise at least one light-emitting diode (LED) presenting characteristics selected as a function of the nominal voltage across the terminals of the corresponding module, of its resistances in the on state and in the off state, and of its “knee” voltage, characterizing switchover from the off state to the on state. In a first variant, each two-terminal element of a balancing circuit may comprise at least two LEDs connected in series and presenting characteristics selected as a function of the nominal voltage across the terminals of the corresponding module, as a function of their resistances in the on state and in the off state, and as a function of their knee voltages. In a second variant, each two-terminal element of the balancing circuit may comprise one or more LEDs connected in series with at least one auxiliary two-terminal circuit such as a resistor, presenting characteristics that are selected as a function of the nominal voltage across the terminals of the corresponding module and of the characteristics of the LEDs (in particular their resistances in the on state and in the off state and their knee voltages). In a third variant, each two-terminal element of the balancing circuit may comprise at least one zener diode connected in series with at least one auxiliary two-terminal circuit such as a resistor and/or one or more LEDs, the zener diode and the auxiliary two-terminal circuit(s) presenting characteristics selected as a function of the nominal voltage across the terminals of the corresponding module, of their resistances in the on state and in the off state, and of their knee voltages.

When the battery modules are identical, the corresponding two-terminal balancing circuits are identical.

The invention is particularly well adapted to batteries whose electrochemical cells are selected from lithium cells, such as, for example: lithium-ion cells (Li/Ion), silver-zinc cells, and polymer cells. However, in general, the invention applies to all batteries in which the various electrochemical cells need to present substantially the same voltage across their terminals in order to optimize performance.

### BRIEF DESCRIPTION OF THE DRAWINGS

Other characteristics and advantages of the invention appear on examining the following detailed description and the accompanying drawing, in which:

FIG. 1 is a diagram of an embodiment of a rechargeable battery of the invention;

FIG. 2 is a diagram of a first variant embodiment of a balancing circuit of the invention;

FIG. 3 is a diagram of a second variant embodiment of a balancing circuit of the invention; and

FIG. 4 is a diagram of a third variant embodiment of a balancing circuit of the invention.

### MORE DETAILED DESCRIPTION

The accompanying drawings may serve not only to contribute to describing the invention, but may also contribute to defining it, where appropriate.

The invention seeks to provide simple, inexpensive, and adaptable balancing of the voltages across the terminals of modules of electrochemical cells making up rechargeable batteries.

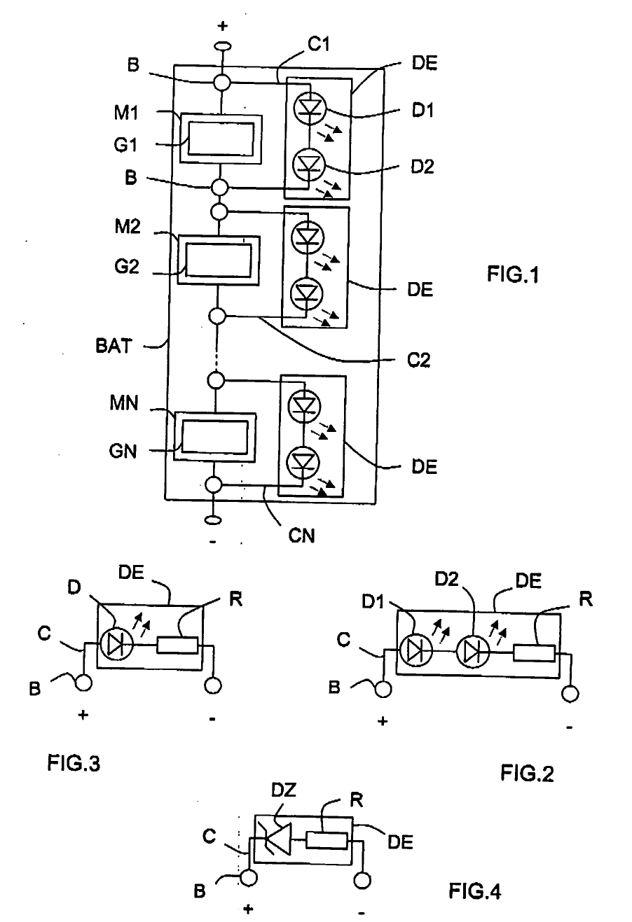

In the example shown in FIG. 1, the rechargeable battery BAT of the invention comprises modules Mi (i=1 to N, where N is not less than two), each module comprising an electrochemical cell Gi, for example a rechargeable cell of the lithium-ion type (Li/Ion).

The invention is not limited to this type of rechargeable cell only. It also applies in particular to silver-zinc cells and to polymer cells.

Furthermore, the invention is not limited to modules Mi that comprise only one rechargeable cell. It applies equally well to batteries in which each module Mi comprises a plurality of electrochemical cells Gij connected in series and/or in parallel.

In general, the invention applies to all batteries in which the various electrochemical cells G need to present substantially the same voltage across their terminals B in order to optimize performance.

According to the invention, the voltages across the terminals B of the modules Mi in the battery BAT are balanced by means of two-terminal balancing circuits Ci, referred to below as circuits Ci.

More precisely, in the invention, a two-terminal balancing circuit Ci is connected across the terminals B of each module Mi, in a parallel configuration.

The term “two-terminal balancing circuit” is used herein to mean a circuit comprising one two-terminal circuit DE or at least two two-terminal circuits DE connected in parallel. Furthermore, the term “two-terminal circuit” is used to mean an assembly including at least one two-terminal circuit component, such as an LED or a zener diode, or an association of a diode (LED or zener diode) with a resistor, and presenting an off state and an on state as a function of the voltage across its terminals.

Each two-terminal balancing circuit Ci serves to take a permanent discharge current in the module Mi to which it is connected in parallel, which discharge current is a function of the voltage across its terminal B, and is of a magnitude suitable for making the self-discharge current of the module Mi negligible when compared therewith.

The current passing through the two-terminal element (s) of a balancing circuit Ci is a function of the voltage across its (their) terminals, which are likewise the terminals B of the corresponding module Mi, and the greater the voltage, the greater the magnitude of the current carried (or “discharge” current, or indeed “bypass” current).

Consequently, when a module Mi presents a level of charge that is greater than that of the other modules Mj (j≈i), it presents a higher discharge current, and it therefore discharges more quickly than they do. In other words, when all of the modules Mi present substantially the same voltage across their terminals B, they all present substantially the same discharge current.

Consequently, in the presence of unbalanced self-discharge between the modules Mi, the battery BAT of the invention is subjected to automatic compensation.

The current I_{module} passing through a module Mi can be considered as being the sum of the self-discharge current I_{self-discharge} of said module plus the discharge current (I₂ₜ) flowing through the circuit Ci (i.e. passing through its two-terminal circuit(s)).

As soon as the discharge currents I₂ₜ is very large compared with the self-discharge current I_{self-discharge}, typically 100 times greater and preferably 1000 times greater, the self-discharge current I_{self-discharge} can be considered as being negligible compared with the discharge current I₂ₜ, so that to a first approximation, I_{module}=I₂ₜ.

The characteristics of the two-terminal circuit(s) constituting each circuit Ci should therefore be selected in such a manner that the above-mentioned condition is satisfied, thus enabling the battery BAT to be balanced naturally and intrinsically. Where necessary (because of the voltage across the terminals B of the modules Mi), each module Mi may be connected to a balancing circuit comprising at least two two-terminal circuits connected in parallel.

A certain number of two-terminal circuits or a combination of two-terminal circuits can be used to satisfy the above condition.

A first type of two-terminal circuit DE comprises LEDs. LEDs are particularly advantageous since they take a discharge current I₂ₜ of less than 3 microamps (μA) when the voltage across their terminals B is less than 3.3 V. For example, for a voltage equal to about 2.7 V (which corresponds to a low voltage for cells Gi of the lithium-ion type), the discharge current I₂ₜ is less than 0.1 μA. Because of such characteristics (in their off state), LEDs serve to avoid the battery BAT becoming completely discharged.

When the two-terminal circuit DE of a circuit CI comprises two LEDs D1 and D2 connected in series, as shown in FIG. 1, the discharge current I₂ₜ passing through them (in their on state) is greater than about 6 milliamps (mA) in the presence of a voltage across their terminals B that is greater than 4 V. Consequently, when the self-discharge current I_{self-discharge} is less than 0.1 μA (as is usually the case in a standard electrochemical cell G), a ratio I₂ₜ over I_{self-discharge} is obtained that is greater than 60,000. Such an arrangement is thus particularly suitable for satisfying the above-specified condition.

By selecting LEDs presenting characteristics that are different from those mentioned above, it is possible to obtain other ratios of I₂ₜ over I_{self-discharge}. Consequently, it is possible to adapt the characteristics of the LEDs as a function of the nominal voltage to be balanced at each module Mi.

Where necessary, the two-terminal circuit DE may include at least one auxiliary two-terminal circuit as shown in FIG. 2, for example a resistor R connected in series with the two LEDs D1 and D2 so that together they take a discharge current that matches the nominal voltage across the terminals of the modules Mi due to its resistances in the on state and in the off state and due to its knee voltage.

Instead of having two LEDs connected in series, the two-terminal circuit DE of a balancing circuit Ci may comprise a single LED D1 connected in series with at least one auxiliary two-terminal circuit, such as a resistor R, for example, and as shown in FIG. 3.

It is also possible to envisage that the two-terminal circuit DE is constituted by a single LED only, in particular a so-called “white” diode, for example.

In another variant, shown in FIG. 4, the two-terminal circuit DE of a balancing circuit Ci may comprise at least one zener diode DZ connected in series with at least one auxiliary two-terminal circuit such as a resistor R or an LED. The resistor is needed since the zener diode DZ in the on state presents resistance that is equivalent to about 10 ohms (Ω). Under such circumstances, for reasons of performance, it is preferable for the resistance of the resistor R that is used to be small, typically lying in the range 100 Ω to 10,000 Ω.

The use of one or more LEDs presents an advantage compared with other types of two-terminal circuit components because it enables proper operation of the modules to be checked. For example, one type of LED can light up when the voltage across the terminals B of the module Mi is greater than about 3.5 V, and switch off when said voltage is less than about 3 V.

Whatever the way in which the balancing circuit Ci is embodied, the characteristics of its two-terminal circuit(s) DE (and thus of its component(s)) are selected as a function of the nominal voltage across the terminals of the corresponding module Mi, of its resistances in the on state and in the off state, and of its knee voltage.

It is important to observe that in the presence of identical modules Mi, the two-terminal balancing circuits Ci are all identical. However, if the modules Mi are different, then the two-terminal balancing circuits Ci differ so that each of them is adapted respectively to the corresponding modules Mi.

By means of the invention, batteries are not limited concerning the number of electrochemical cells connected in series, since it suffices to couple each module to a balancing circuit that is adapted to its nominal voltage.

Furthermore, the invention provides balancing that is particularly simple and of cost that is low or very low, thus enabling it to be used in numerous applications.

The invention is not limited to the battery embodiments described above purely by way of example, but it covers any variant that might be envisaged by the person skilled in the art within the ambit of the following claims.

1. A rechargeable battery comprising at least two modules connected in series via their terminals and each comprising at least one electrochemical cell, the battery including two-terminal balancing circuits respectively connected in parallel with the terminals of said modules and arranged to take a permanent discharge current in the corresponding module as a function of the voltage across its terminals.

2. A battery according to claim 1, wherein each module is connected via its terminals to a balancing circuit comprising at least two two-terminal circuits connected in parallel and arranged together to take a permanent discharge current in said module that is a function of the voltage at its terminals.

3. A battery according to claim 1, wherein each two-terminal circuit presents at least an off state and an on state.

4. A battery according to claim 3, wherein each two-terminal circuit comprises at least a first LED having characteristics selected as a function of the nominal voltage across the terminals of the corresponding module, of its resistances in the on state and in the off state, and of its “knee” voltage.

5. A battery according to claim 4, wherein each two-terminal circuit comprises at least one second LED connected in series with said first LED and having characteristics selected as a function of the nominal voltage across the terminals of the corresponding module, of its resistances in the on state and in the off state, and of its “knee” voltage.

6. A battery according to claim 4, wherein each two-terminal circuit comprise at least one auxiliary two-terminal circuit connected in series with said first LED and presenting characteristics selected as a function of the nominal voltage across the terminals of the corresponding module and of the characteristics of said first and/or second LEDs.

7. A battery according to claim 3, wherein each two-terminal circuit comprises at least one zener diode connected in series with at least one auxiliary two-terminal circuit, said zener diode and the auxiliary two-terminal circuit presenting characteristics selected as a function of the nominal voltage across the terminals of the corresponding module, of its resistances in the on state and in the off state, and of its “knee” voltage.

8. A battery according to claim 6, wherein said auxiliary two-terminal circuit is selected from a group comprising at least one resistor and an LED.

9. A battery according to claim 1, wherein said modules are identical, and said corresponding two-terminal balancing circuits are identical.

10. A battery according to claim 1, wherein each electrochemical cell is selected from a group comprising at least lithium cells, and in particular lithium-ion cells, silver-zinc cells, and polymer cells.
